(19) United States
(12) Patent Application Publication
(10) Pub. No.: US 2025/0214671 A1
(43) Pub. Date: Jul. 3, 2025

(54) MULTIFUNCTIONAL WHEELED VEHICLE

(71) Applicant: LIVEN SPORTS MFG. (Xiamen) Co., Ltd., Xiamen (CN)

(72) Inventor: Jen-Hung WANG, Taipei City (TW)

(21) Appl. No.: 18/400,593

(22) Filed: Dec. 29, 2023

(51) Int. Cl. B62K 9/02; B62J 1/08; B62J 25/04

(52) U.S. Cl. CPC B62K 9/02; B62J 1/08; B62J 25/04

(57) ABSTRACT

A multifunctional wheeled vehicle comprises an elongated-foot-deck. One end of the elongated-foot-deck has an upright rod. A bottom end of the upright rod has at least one front wheel. A first-adapter-member is provided above the upright rod. A first-positioning-portion is provided above the first-adapter-member for detachably positioning a handle when an elongated-seat is in a horizontal state. The other end of the elongated-foot-deck has a rear wheel. One end of the elongated-seat has a second-adapter-member. The second-adapter-member is connected to the first-adapter-member such that the elongated-seat is rotated into the horizontal or an upright state. The other end of the elongated-foot-deck has a second-positioning-portion for detachably positioning the handle when the elongated-seat is in the upright state, whereby the user can choose to ride in a standing or sitting position after rotating and positioning the elongated-seat.

### FIELD OF THE INVENTION

The present invention is related to a multifunctional wheeled vehicle structure, especially refers to one that can rotate an elongated seat to allow the user to choose to ride in a standing or sitting position.

### BACKGROUND OF THE INVENTION

Since scooters are quite light and have excellent flexibility, they are generally loved by people and have become popular in various places. But whether it is a traditional human-powered scooter or an electric scooter, the user must stand on the pedals when using it. For younger children, riding on a scooter poses a higher risk. Therefore, it is generally used as a seated two-wheeled vehicle or a three-wheeled vehicle, and an auxiliary push rod is even installed at the rear of the wheeled vehicle to allow adults to control the direction from the rear.

However, in actual use, the above two types of wheeled vehicles can only produce individual functions, but they cannot replace each other. When different needs arise as a child grows, or when two users of different ages have different needs, they need to be purchased separately, which will increase the user's financial burden and require more storage space.

### SUMMARY OF THE INVENTION

In view of this, in order to provide a structure that is different from the conventional technology and improve the above-mentioned shortcomings, the applicant has accumulated many years of experience and continuous research and development and improvement, and thus came into being the present invention.

One of the objects of the present invention is to improve conventional scooters and children's wheel scooters, which can only produce individual functions, but cannot replace each other. When there are different use needs, they need to be purchased separately, which will increase the financial burden of the user and has the disadvantages of requiring more storage space. By providing an elongated seat with a positioning portion at both ends and a multifunctional wheeled vehicle structure that allows a first adapter member and a second adapter member to be separated or securely connected, different modes of standing or sitting postures can be converted to meet different usage needs, thereby saving the cost of purchasing different wheeled vehicles and saving storage space.

To achieve the object of the present invention, the multifunctional wheeled vehicle structure of the present invention mainly comprises an elongated foot deck and an elongated seat. An upright rod is provided at one end of the elongated foot deck along a lengthwise direction of the elongated foot deck. A bottom end of the upright rod has at least one front wheel. A first adapter member is provided above the upright rod. A first positioning portion is provided above the first adapter member. The first positioning portion is used for detachably positioning a bottom end of a handle when the elongated seat is in a horizontal state. A rear wheel is provided at the other end of the elongated foot deck along the lengthwise direction of the elongated foot deck. A second adapter member is provided at one end of the elongated seat along a lengthwise direction of the elongated seat. The second adapter member is connected to the first adapter member such that the elongated seat is rotated into the horizontal state or an upright state. A second positioning portion is provided at the other end of the elongated seat along the lengthwise direction of the elongated seat. The second positioning portion is used for detachably positioning the bottom end of the handle when the elongated seat is in the upright state.

In implementation, the first adapter member comprises a base and a fixing member, a top end of the base has a first bevel portion, a center of the first bevel portion has a first sleeve portion; the fixing member comprises a connecting rod, the connecting rod passes through the first sleeve portion, and one end of said connecting rod has a fixing piece, the other end of said connecting rod has a linking piece; the second adapter member has a second bevel portion, a center of the second bevel portion has a second sleeve portion, the second sleeve portion is used for sleeving on the first sleeve portion such that the first bevel portion and the second bevel portion are capable of rotating relative to each other coaxially, one end of the second sleeve portion has a limiting groove, the limiting groove is used for accommodating and limiting the linking piece.

In implementation, a peripheral edge of the first bevel portion has a first stop portion and a second stop portion, the first stop portion and the second stop portion are respectively located at two opposite sides of the first bevel portion, a peripheral edge of the second bevel portion has a stopping part, the stopping part is selectively abutted against the first stop portion or the second stop portion such that the elongated seat is rotated and positioned into the horizontal state or the upright state.

In implementation, the first positioning portion is provided above the one end of the elongated seat along the lengthwise direction of the elongated seat.

In implementation, is provided at the bottom end of the handle has an elastic buckle; the first positioning portion comprises a upright groove, a first through hole, a first positioning groove and a first pressing piece, the upright groove is in communication with the first positioning groove through the first through hole; the bottom end of the handle is limited in the upright groove, the elastic buckle is limited in the first through hole; the first pressing piece is limited in the first positioning groove in an elastically stretchable and contractible manner, and one side of the first pressing piece has a pressing block, the pressing block is used for pushing the elastic buckle when the first pressing piece moves in a direction parallel to an axis of the handle.

In implementation, the second positioning portion comprises a transverse groove, a second through hole, a second positioning groove and a second pressing piece, the transverse groove is in communication with the second positioning groove through the second through hole; the second pressing piece is limited in the second positioning groove in an elastically stretchable and contractible manner, and the second pressing piece is coaxially provided with a pushing rod, the pushing rod is used for pushing the elastic buckle of the handle when the second pressing piece moves in a direction perpendicular to the axis of the handle.

In implementation, the present invention further comprises a left pedal and a right pedal, a bottom surface of the elongated foot deck has a left limiting piece and a right limiting piece, one end of the left pedal is pivoted to the elongated foot deck, and the one end of the left pedal has a left limiting portion, the left limiting portion corresponds to and limits the left limiting piece such that the left pedal is fixed at a rotation angle; one end of the right pedal is pivoted to the elongated foot deck, and the one end of the right pedal has a right limiting portion, the right limiting portion corresponds to and limits the right limiting piece such that the right pedal is fixed at a rotation angle.

In implementation, the present invention further comprises two rotating wheels and an auxiliary pushing rod, the two rotating wheels are respectively connected to the other end of the elongated foot deck along the lengthwise direction of the elongated foot deck and located at two sides of the rear wheel, a height of each of the two rotating wheels is greater than a height of the rear wheel such that the rear wheel is elevated; when the elongated seat is in the horizontal state, one end of the auxiliary pushing rod is detachably connected to the second positioning portion.

For further understanding the characteristics and effects of the present invention, some preferred embodiments referred to drawings are in detail described as follows.

### BRIEF DESCRIPTION OF DRAWINGS

FIG. 1 is a perspective view of a preferred embodiment of the present invention.

FIG. 2 is a component exploded view of a preferred embodiment of the present invention.

FIG. 3 is a perspective view of a first adapter member of the present invention.

FIG. 4 is a schematic view of a state of a left pedal and a right pedal of the present invention.

FIG. 5 is a schematic sectional view of an elongated seat of the present invention in a horizontal state.

FIG. 6 is a schematic sectional view of an elongated seat of the present invention rotated to an upright state.

FIG. 7 is a perspective view of an elongated seat of the present invention in an upright state.

FIG. 8 is a perspective view of another embodiment of the present invention.

### DETAILED DESCRIPTIONS OF PREFERRED EMBODIMENTS

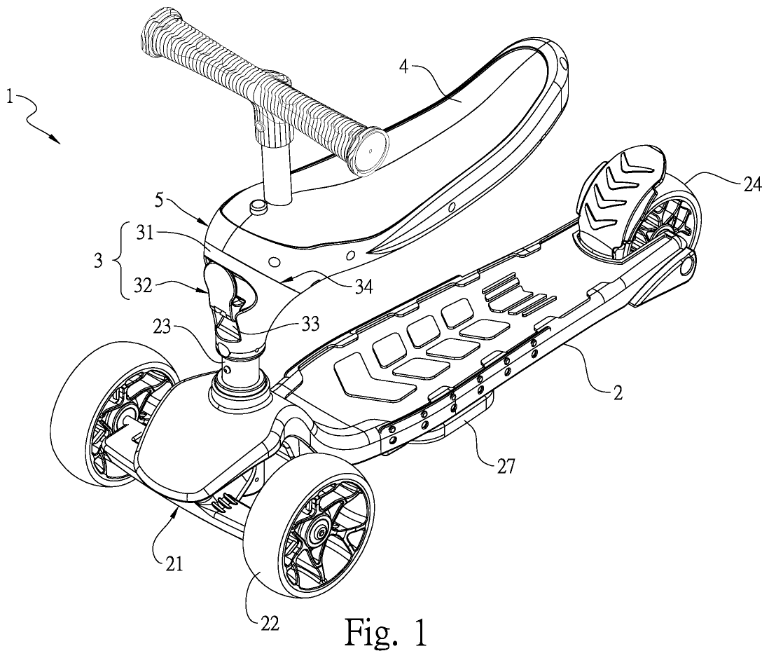

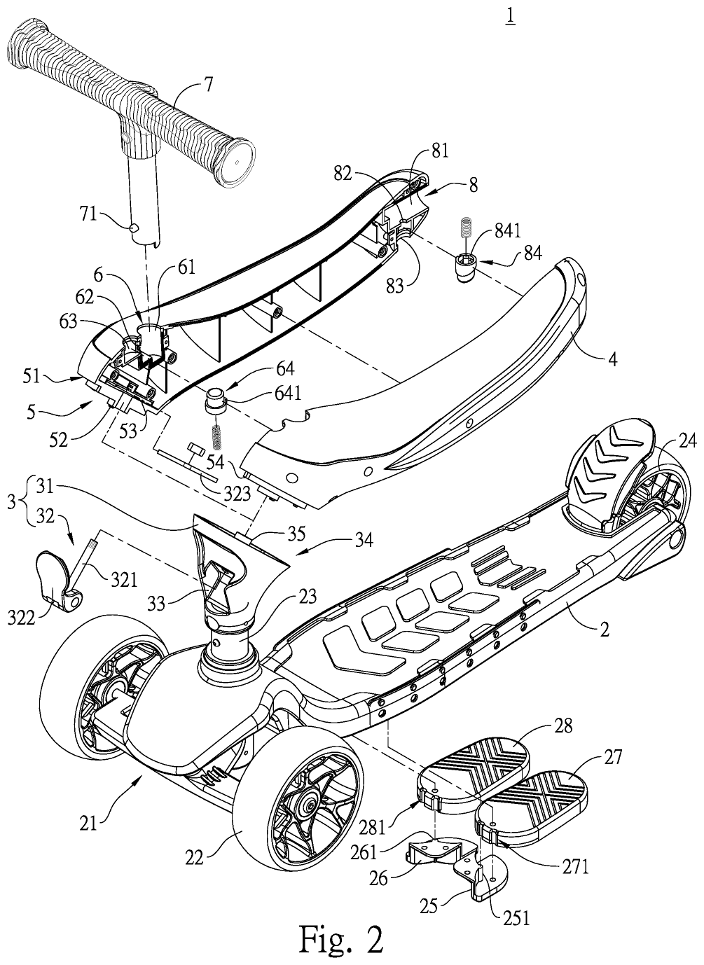

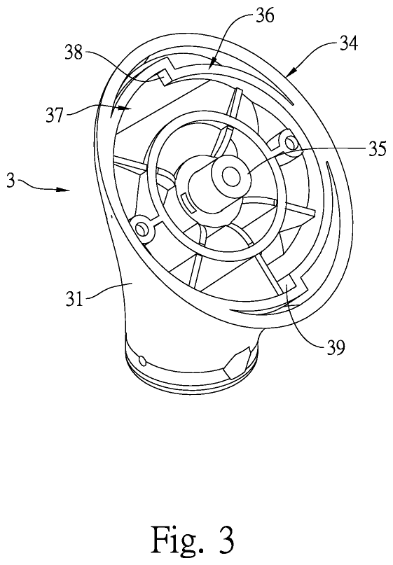

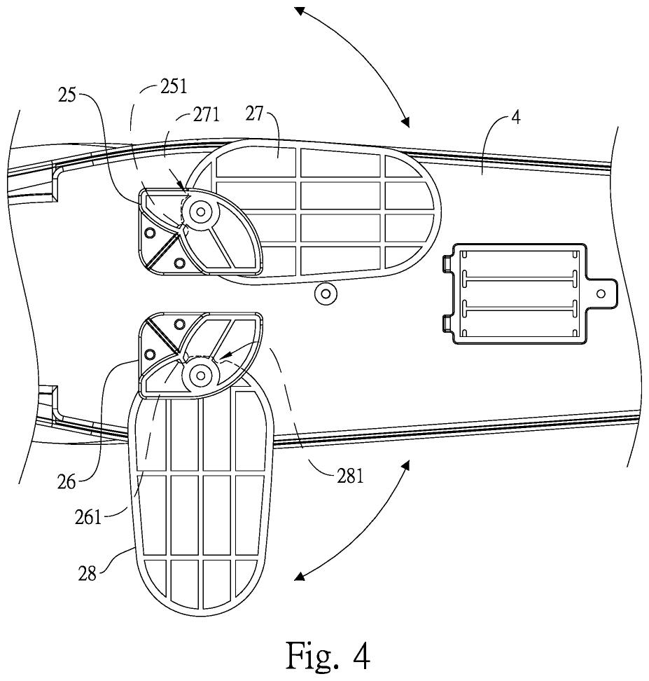

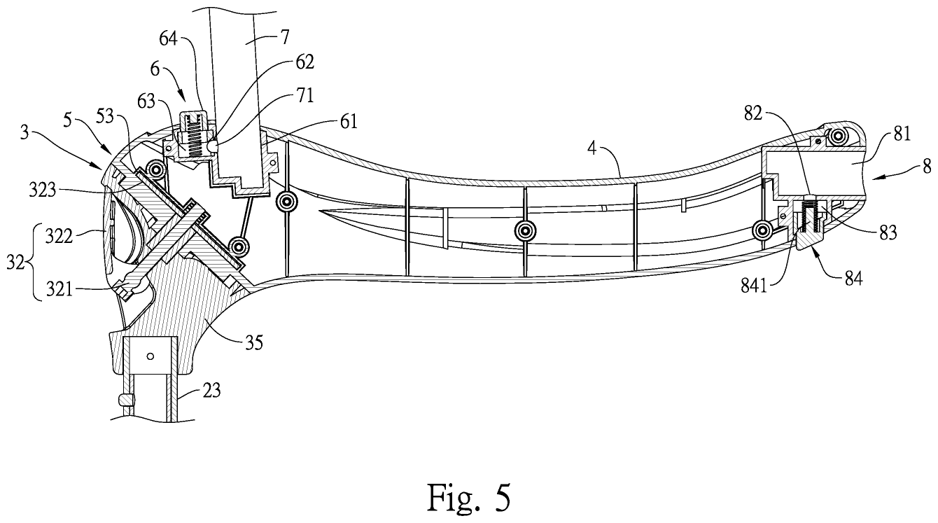

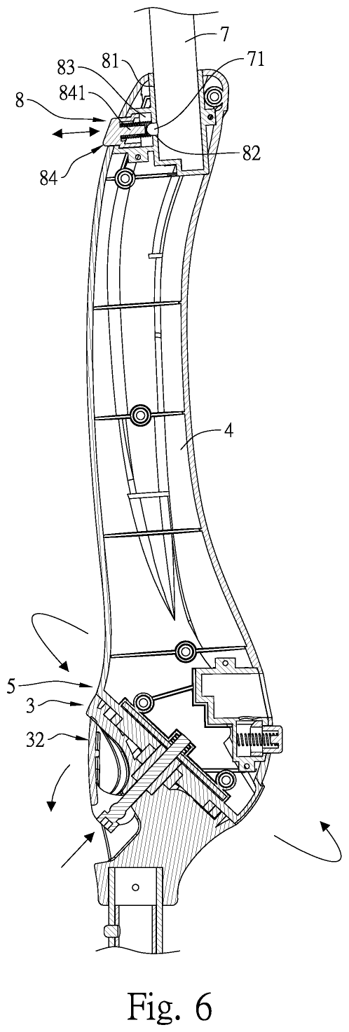

Please refer to FIGS. 1-6, which show a preferred embodiment of a multifunctional wheeled vehicle of the present invention. The multifunctional wheeled vehicle structure 1 mainly comprises an elongated foot deck 2, a first adapter member 3, an elongated seat 4 and a second adapter member 5. In current embodiment, one end of the elongated foot deck 2 along a lengthwise direction of the elongated foot deck 2 is defined as a front end, and the other end of the elongated foot deck 2 along the lengthwise direction of the elongated foot deck 2 is defined as a rear end. The front end of the elongated foot deck 2 has a vehicle head 21. A bottom end of the vehicle head 21 has two front wheels 22. In implementation, the bottom end of the vehicle head 21 may have one front wheel 22. A top end of the vehicle head 21 has an upright rod 23. The rear end of the elongated foot deck 2 has a rear wheel 24. A bottom surface of the elongated foot deck 2 is connected to a left limiting piece 25 and a right limiting piece 26. The left limiting piece 25 has a first convex arc block 251. The right limiting piece 26 has a second convex arc block 261. One end of a left pedal 27 and one end of a right pedal 28 are respectively pivoted to the elongated foot deck 2, and the one end of the left pedal 27 has two grooves on the same arc surface, wherein the two grooves are combined into a left limiting portion 271, and the one end of the right pedal 28 has another two grooves on the same arc surface, wherein the another two grooves are combined into a right limiting portion 281. Thereby, by rotating the left pedal 27 and the right pedal 28 respectively, the left pedal 27 and the right pedal 28 are capable of being respectively fixed at a folded rotation angle or an unfolded rotation angle.

The first adapter member 3 is linked to a top end of the upright rod 23. The first adapter member 3 comprises a base 31 and a fixing member 32. A front end of the base 31 has an accommodation groove 33. A top end of the base 31 has a first bevel portion 34 inclined downward toward a rear end of the base 31. A center of the first bevel portion 34 has a sleeve. The sleeve serves as a first sleeve portion 35. One end of the first sleeve portion 35 is in communication with the accommodation groove 33. An inner peripheral edge of the first bevel portion 34 has a half annulus area 36 and a half annulus groove 37. One end of the half annulus area 36 serves as a first stop portion 38, the other end of the half annulus area 36 serves as a second stop portion 39. The fixing member 32 comprises a connecting rod 321. The connecting rod 321 passes through the first sleeve portion 35. One end of the connecting rod 321 has a cam lever. The cam lever serves as a fixing piece 322. The fixing piece 322 is limited in the accommodation groove 33. The other end of the connecting rod 321 is locked to and connected to a sheet pressing plate. The sheet pressing plate serves as a linking piece 323.

A front end of the elongated seat 4 has a second adapter member 5. The second adapter member 5 has a second bevel portion 51 inclined downward toward a rear end of the elongated seat 4. A center of the second bevel portion 51 has a second sleeve portion 52. The a second sleeve portion 52 is sleeved on the first sleeve portion 35 such that the first bevel portion 34 and the second bevel portion 51 are rotating relative to each other coaxially. One end of the second sleeve portion 52 has a limiting groove 53. The limiting groove 53 accommodates and limits the linking piece 323 of the connecting rod 321. Thereby, after toggling the fixing piece 322, the elongated seat 4 is tightly connected to the first adapter member 3, or the elongated seat 4 is being in a rotatable state. Moreover, a peripheral edge of the second bevel portion 51 has a protruding block. The protruding block serves as a stopping part 54. The stopping part 54 is limited in the half annulus groove 37. When the elongated seat 4 is in a horizontal state, the stopping part 54 is abutted against the first stop portion 38; while the elongated seat 4 is rotated into an upright state, the stopping part 54 is abutted against the second stop portion 39, so as to limit the rotation angle of the elongated seat 4.

A first positioning portion 6 is provided above the front end of the elongated seat 4. The first positioning portion 6 comprises a upright groove 61, a first through hole 62, a first positioning groove 63 and a first pressing piece 64. The upright groove 61 is in communication with the first positioning groove 63 through the first through hole 62. The first pressing piece 64 has a compression spring such that the first pressing piece 64 is limited in the first positioning groove 63 in an elastically stretchable and contractible manner. One side of the first pressing piece 64 has a pressing block 641. When the elongated seat 4 is in the horizontal state, a bottom end of a handle 7 is plugged in the upright groove 61, and an elastic buckle 71 of the bottom end of the handle 7 is limited in the first through hole 62 such that the handle 7 is securely positioned above the elongated seat 4; while an user pressing the first pressing piece 64, the first pressing piece 64 moves in a direction parallel to an axis of the handle 7 such that the pressing block 641 pushes the elastic buckle 71 to let the handle 7 to be separated from the elongated seat 4.

The rear end of the elongated seat 4 has a second positioning portion 8. The second positioning portion 8 comprises a transverse groove 81, a second through hole 82, a second positioning groove 83 and a second pressing piece 84. The transverse groove 81 is in communication with the second positioning groove 83 through the second through hole 82. The second pressing piece 84 is coaxially provided with a pushing rod 841. A compression spring is sleeved on the pushing rod 841 such that the second pressing piece 84 is limited in the second positioning groove 83 in an elastically stretchable and contractible manner. When the elongated seat 4 is rotated to the upright state, the bottom end of the handle 7 is plugged in the transverse groove 81, the elastic buckle 71 is limited in the second through hole 82 such that the handle 7 is securely positioned at the rear end of the elongated seat 4, that is, let the handle 7, the elongated seat 4 and the first adapter member 3 standing in a straight line; while the user pressing the second pressing piece 84, the second pressing piece 84 moves in a direction perpendicular to the axis of the handle 7 such that the pushing rod 841 pushes the elastic buckle 71 to let the handle 7 to be separated from the elongated seat 4.

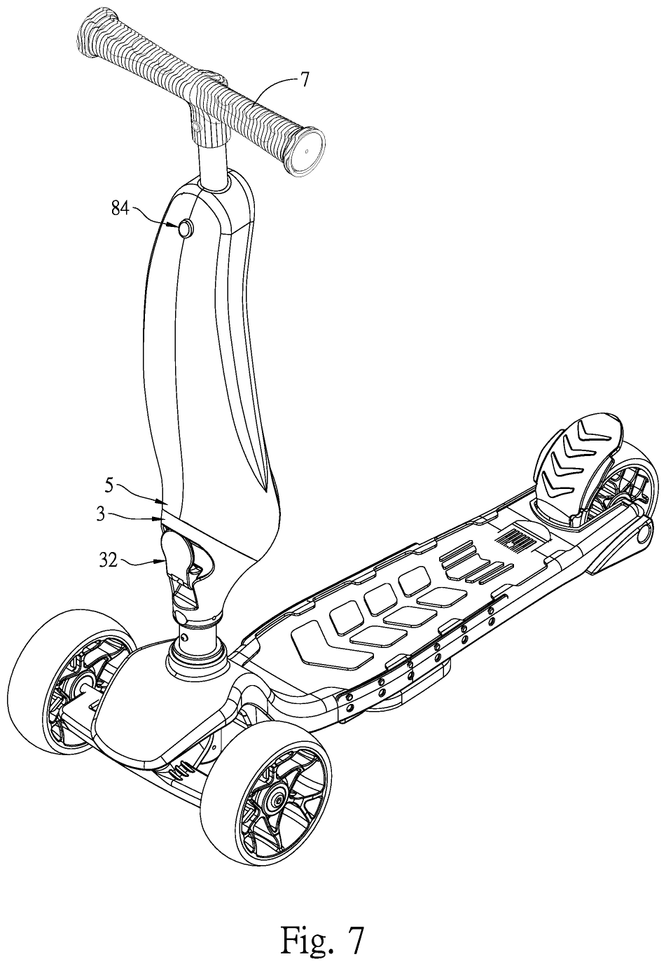

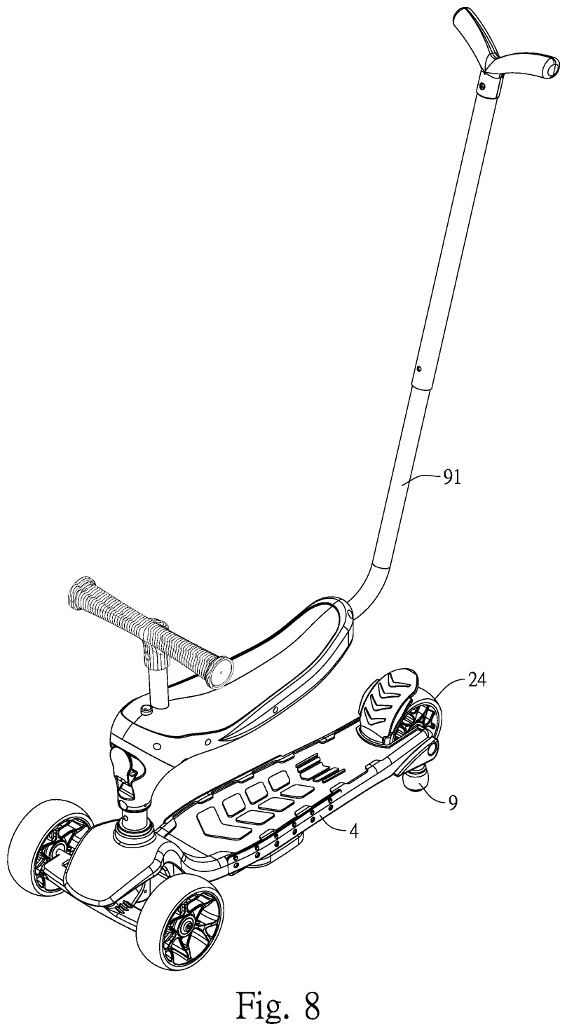

FIGS. 7 and 8 show another embodiment of the present invention. It differs from the preferred embodiment in that: the rear end of the elongated seat 4 is connected to the two rotating wheels 9 respectively. The two rotating wheels 9 are located at two sides of the rear wheel 24. And a height of each of the two rotating wheels 9 is greater than a height of the rear wheel 24 such that the rear wheel 24 is elevated. One end of an auxiliary pushing rod 91 also has an elastic buckle. When the auxiliary pushing rod 91 is securely connected to the second positioning portion 8, the left pedal 27 and the right pedal 28 are stretched respectively, and when an adult pushes or pulls the auxiliary pushing rod 91, the two rotating wheels 9 rotate in different directions, so as to control the direction of the wheeled vehicle.

As disclosed in the above description and attached drawings, the present invention can provide a multifunctional wheeled vehicle structure that can be selectively converted into standing or sitting postures to meet different usage needs, thereby saving the cost of purchasing different wheeled vehicles and saving storage space. It is new and can be put into industrial use. Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A multifunctional wheeled vehicle, comprising:
an elongated foot deck, wherein an upright rod is provided at one end of said elongated foot deck along a lengthwise direction of said elongated foot deck, a bottom end of said upright rod has at least one front wheel, a first adapter member is provided above said upright rod, a first positioning portion is provided above said first adapter member, a rear wheel is provided at the other end of said elongated foot deck along said lengthwise direction of said elongated foot deck; and
an elongated seat, wherein a second adapter member is provided at one end of said elongated seat along a lengthwise direction of said elongated seat, said second adapter member is connected to said first adapter member, such that said elongated seat is rotated into a horizontal state or an upright state, said first positioning portion is used for detachably positioning a bottom end of a handle when said elongated seat is in said horizontal state, a second positioning portion is provided at the other end of said elongated seat along said lengthwise direction of said elongated seat, said second positioning portion is used for detachably positioning said bottom end of said handle when said elongated seat is in said upright state.

2. The multifunctional wheeled vehicle according to claim 1, wherein said first adapter member comprises a base and a fixing member, a top end of said base has a first bevel portion, a center of said first bevel portion has a first sleeve portion; said fixing member comprises a connecting rod, said connecting rod passes through said first sleeve portion, and one end of said connecting rod has a fixing piece, the other end of said connecting rod has a linking piece; said second adapter member has a second bevel portion, a center of said second bevel portion has a second sleeve portion, said second sleeve portion is used for sleeving on said first sleeve portion such that said first bevel portion and said second bevel portion are capable of rotating relative to each other coaxially, one end of said second sleeve portion has a limiting groove, said limiting groove is used for accommodating and limiting said linking piece.

3. The multifunctional wheeled vehicle according to claim 2, wherein a peripheral edge of said first bevel portion has a first stop portion and a second stop portion, said first stop portion and said second stop portion are respectively located at two opposite sides of said first bevel portion, a peripheral edge of said second bevel portion has a stopping part, said stopping part is selectively abutted against said first stop portion or said second stop portion such that said elongated seat is rotated and positioned into said horizontal state or said upright state.

4. The multifunctional wheeled vehicle according to claim 2, wherein said bottom end of said handle has an elastic buckle; said first positioning portion comprises a upright groove, a first through hole, a first positioning groove, and a first pressing piece, said upright groove is in communication with said first positioning groove through said first through hole; said bottom end of said handle is limited in said upright groove, said elastic buckle is limited in said first through hole; said first pressing piece is limited in said first positioning groove in an elastically stretchable and contractible manner, and one side of said first pressing piece has a pressing block, said pressing block is used for pushing said elastic buckle when said first pressing piece moves in a direction parallel to an axis of said handle.

5. The multifunctional wheeled vehicle according to claim 1, wherein said first positioning portion is provided above said one end of said elongated seat along said lengthwise direction of said elongated seat.

6. The multifunctional wheeled vehicle according to claim 5, wherein said second positioning portion comprises a transverse groove, a second through hole, a second positioning groove and a second pressing piece, said transverse groove is in communication with said second positioning groove through said second through hole; said second pressing piece is limited in said second positioning groove in an elastically stretchable and contractible manner, and said second pressing piece is coaxially provided with a pushing rod, said pushing rod is used for pushing said elastic buckle of said handle when said second pressing piece moves in a direction perpendicular to said axis of said handle.

7. The multifunctional wheeled vehicle according to claim 1, further comprising a left pedal and a right pedal, a bottom surface of said elongated foot deck has a left limiting piece and a right limiting piece, one end of said left pedal is pivoted to said elongated foot deck, and said one end of said left pedal has a left limiting portion, said left limiting portion corresponds to and limits said left limiting piece such that said left pedal is fixed at a rotation angle; one end of said right pedal is pivoted to said elongated foot deck, and said one end of said right pedal has a right limiting portion, said right limiting portion corresponds to and limits said right limiting piece such that said right pedal is fixed at a rotation angle.

8. The multifunctional wheeled vehicle according to claim 1, further comprising two rotating wheels and an auxiliary pushing rod, said two rotating wheels are respectively connected to said the other end of said elongated foot deck along said lengthwise direction of said elongated foot deck and located at two sides of said rear wheel, a height of each of said two rotating wheels is greater than a height of said rear wheel such that said rear wheel is elevated; when said elongated seat is in said horizontal state, one end of said auxiliary pushing rod is detachably connected to said second positioning portion.
